(19) United States
(12) Patent Application Publication
(10) Pub. No.: US 2018/0016762 A1
(43) Pub. Date: Jan. 18, 2018

(54) ON-BOARD SPOOL-ABLE RE-USEABLE CONTAINMENT BOOM AND CONTROL SYSTEM

(71) Applicants: Michael T. Miller, Covington, LA (US); Terry Hall, Metairie, LA (US)

(72) Inventors: Michael T. Miller, Covington, LA (US); Terry Hall, Metairie, LA (US)

(21) Appl. No.: 15/715,740

(22) Filed: Sep. 26, 2017

Related U.S. Application Data
(63) Continuation-in-part of application No. 15/235,306, filed on Aug. 12, 2016, now Pat. No. 9,809,942.
Application No. 15/235,306 is a continuation of application No. 14/730,778, filed on Jun. 4, 2015, now Pat. No. 9,487,926.
Application No. 14/730,778 is a continuation-in-part of application No. 12/902,282, filed on Oct. 12, 2010, now Pat. No. 9,206,575.

(51) Int. Cl. E02B 15/08; E02B 15/04; E02B 15/06; G05D 16/20

(52) U.S. Cl. CPC E02B 15/0871; G05D 16/2026; E02B 15/0864; E02B 15/0842; E02B 15/047; E02B 15/0814; E02B 15/0807; E02B 15/06; E02B 15/0828

(57) ABSTRACT

An on-board spool-able re-useable containment boom for a waterborne vessel that lies substantially flat and capable of being spooled when deflated and floats in the proper orientation when inflated, that has spool-able re-inflatable float sections which are sequentially inflated during deployment and sequentially deflated during recovery, that can be repeatedly deployed and recovered for the purposes of training and testing, and that can be deployed immediately upon occurrence of an oil spill from a waterborne vessel because of its on-board location and its rapid deployment, and a control system for proper inflation and deflation of spool-able re-useable containment boom during deployment and recovery.

### CROSS-REFERENCE TO RELATED APPLICATIONS

This application is a continuation-in-part of my co-pending application Ser. No. 15/235,306, filed Aug. 12, 2016 for an “On-Board Re-Inflatable Containment Boom and Control System,” which is a continuation of my application Ser. No. 14/730,778, filed on Jun. 4, 2015 for an “On-Board Re-Inflatable Containment Boom and Control System,” issued on Nov. 8, 2016 as U.S. Pat. No. 9,487,926, which was a continuation-in-part of my application Ser. No. 12/902,282, filed on Oct. 12, 2010 for an “Onboard Oil Containment System, issued on Dec. 8, 2015 as U.S. Pat. No. 9,206,575, the full disclosures of which are incorporated by reference herein and priority of which is hereby claimed.

### BACKGROUND

This invention provides an on-board spool-able re-useable containment boom for a waterborne vessel that can be repeatedly deployed and recovered for the purposes of training and testing, and that can be deployed immediately upon occurrence of an oil spill from a waterborne vessel, as well as a corresponding control system for proper inflation and deflation during deployment and recovery.

For many years, conventional floating oil booms or barriers have been used in an attempt to contain floating material on or just below the surface of a body of water, such as hydrocarbons. Conventional floating booms are either housed on a shore-based response vessel or directly on land, typically miles or hours away from the spill site, and in a deflated state. When needed, these booms are deployed by attaching the leading end of the boom to a deployment vessel, which tows the boom into place and inflates the boom from the leading end. These booms are normally comprised of an elongated tubular body, and are sometimes sectioned into self-contained inflatable gas bladders that are produced by the inflation of a sealed tube, or each inflatable gas bladder, to which an oil-confining skirt or other flap suitable for containing floatable material is attached. See, for example, U.S. Pat. Nos. 2,682,151 and 3,494,132 which disclose a series of plastic tubes that are interconnected by sleeves with the plastic tubes, which are then inflated to achieve the inflated state of the boom. Additionally, U.S. Pat. No. 4,325,653 discloses dual inflatable tubes with a skirt in between with these inflatable tubes, which are inflated with external inflatable gas hoses. Another example is U.S. Pat. No. 4,123,911, which discloses a gas-inflatable boom wherein a single inflatable boom is inflated from an inflatable gas supply on the deploying vessel.

The patents cited above each contemplate inflation from the leading edge of the boom one section at a time, and do not disclose any method of the continuous inflation of the boom from a single inflatable gas source originating at the lagging last-off section of boom that runs concurrently with the boom. Nor do these patents disclose inflation from an inflatable gas source already connected to the boom prior to deployment.

U.S. Pat. No. 3,792,589 discloses a collapsible boom containing an individual inflation chamber. However, each inflation chamber must be connected to an inflatable gas supply and inflated separately as the boom is deployed. This greatly increases the time and complexity of inflation and deployment. The '589 Patent additionally makes no mention of an equalized, pressurized inflatable gas supply running concurrently with the boom to allow for rapid inflation.

U.S. Pat. No. 5,022,785 discloses a method wherein a reactant body is contained within the boom itself such that by mechanical action the reactants can be activated to release an inflating gas by chemical reaction. After inflation by chemical reaction of the reactant, the boom is inflated with pressurized inflatable gas from the first off, or leading, end to ensure proper inflation. The boom of the '785 Patent may accordingly only be used a single time and then must be replaced.

Further, U.S. Pat. Nos. 5,022,785 and 5,346,329 disclose individualized compartments or compartments separated by valves for the purpose of preventing deflation of an entire section of boom. Neither of these patents discloses an inflatable gas being supplied to the individual compartment from an external, individualized source.

The above patents and current practices are employed to respond to discharges of floatable material on water surfaces, such as hydrocarbons, but thus fail to disclose a rapidly deployable system with a retaining boom that can be deployed from a single point, without need for multiple power sources, and which can withstand ruptures and leaks. The patents recited above also are restricted in the functional length of a single floating barrier, or boom, because they lack an inflatable gas delivery line that runs concurrently with the entire length of boom. Further, current methods and practices require that vessels for the deployment and inflation of the boom, containment machinery, and booms be transported, often from considerable distances, to the site of a discharge on the water. This delay results in increased, un-contained discharges of toxins onto the water. Consequently, it is an object of this present invention to provide for an on-site or on-board system that incorporates a power system and inflatable gas supply to the winch-reel assembly and boom that will allow rapid boom deployment, control of the winch-reel assembly and control, the rate of deployment of the boom from a reel or other storage area.

Another object of this invention is to provide for a power system for rewinding of deployed boom onto a reel or other storage area without interruption to already inflated areas of the boom.

Another object of this invention is to provide a floating barrier deployment system that can be deployed and inflated from a single point inflatable gas supply originating from the lagging, or last-off, end of the boom.

Still another object of this invention is to supply inflatable gas to the boom, or inflatable gas bladders or inflatable gas compartments within the boom, from an individualized inflation point directly associated with the specific boom for inflatable gas bladders or inflatable gas compartments within the boom, said inflatable gas supply originating from the inflatable gas delivery hose in the proximity of the lagging, or last-off, end of the boom and having an equalized internal pressure not exceeding the pressure containing capabilities of the boom, or inflatable gas bladders or inflatable gas compartments within the boom.

Still another object of this invention is to supply an inflatable gas to the boom, or inflatable gas bladders or inflatable gas compartments within the boom, from an individualized inflation point directly associated with the specific boom, or inflatable gas bladders or inflatable gas compartments within the boom, such that the inflatable gas is supplied through a hose running externally and concurrently with the boom. Such a design allows for the boom to be continuously inflated from an inflatable gas supply originating from the inflatable gas delivery hose in the proximity of the non-leading, or last-off, end of the boom.

Yet another object of this invention is to provide inflating medium, such as air, to inflate the floating barrier from a single point supply that can inflate the entire floating barrier and continuously maintain inflation of the floating barrier once deployed and inflated.

Yet another object of this invention is to provide for a containment system that can be rapidly transported via helicopter to a discharge site for rapid deployment.

Still another object of this invention is to provide a floating barrier deployment system and floating barrier that is not limited in the length of the floating barrier that can be deployed, inflated and maintained in an inflated state.

Furthermore, it is an object of this invention to provide a control mechanism for deployment, inflation and maintenance of a floating barrier that allows the operator to control, from a single point, the rate of deployment and inflation of a floating barrier.

Yet another object of this invention is to allow for a floating barrier deployment system and floating barrier to be housed on marine vessels or at stationary points, including without limitation docks, ports, shores, islands, seawalls, dikes, skimming vessels, barges, ocean going vessels, rescue vessels, drilling rigs, boats, pontoons, and platforms, or to close proximity of the oil being transported, shipping lanes, or stored in the event of a spill.

Yet another object of this invention is to allow for the deployment, inflation, maintenance, and directional control of the deployed and inflated boom without the use of a secondary deployment vehicle.

And lastly, it is a further object of the invention to allow for the directional control of the deployed, inflated boom without the benefit of a secondary deployment vessel.

### SUMMARY OF THE INVENTION

The present invention provides an on-board spool-able re-useable containment boom for a waterborne vessel that lies substantially flat and is capable of being spooled when deflated, and floats in the proper orientation when inflated, that has spool-able re-inflatable float sections that are sequentially inflated during deployment and sequentially deflated during recovery, that can be repeatedly deployed and recovered for the purposes of training and testing, and that can be deployed immediately upon occurrence of an oil spill from a waterborne vessel because of its on-board location and its rapid deployment, as well as a control system for proper inflation and deflation during deployment and recovery.

The on-board spool-able re-useable containment boom and control system adapt to changing circumstances of atmospheric pressure, air and water temperatures and turbulence, speed of deployment or recovery, and size of boom, and provide updated optimal positive and negative pneumatic pressures to facilitate operation without damage to the boom and without premature or delayed inflation or deflation.

The on-board spool-able re-useable containment boom and control system allow for an immediate, effective response to an oil spill or other contaminate spill by utilizing a containment boom that is already on board a vessel, can be deployed very quickly, and can be deployed, recovered, and re-deployed many times, for training and testing of personnel and equipment, which leads to more effective responses to actual oil spills.

### BRIEF DESCRIPTION OF DRAWINGS

Reference will now be made to the drawings, wherein like parts are designated by like numerals, and wherein:

FIG. 1 is a schematic view of the invention being inflated and deployed;

FIG. 2 is a partially cutaway view of the spool-able re-useable containment boom of the invention;

FIG. 3 is a schematic view illustrating the spool-able re-useable containment boom of the invention inflated;

FIG. 4 is a schematic view illustrating the spool-able re-useable containment boom of the invention deflated;

FIG. 5 is a schematic view of the filling and emptying valves of the spool-able re-useable containment boom of the invention being inflated;

FIG. 6 is a schematic view of the filling and emptying valves of the spool-able re-useable containment boom of the invention being deflated;

FIG. 7 is a schematic view of the filling and emptying valves of the spool-able re-useable containment boom of the invention in use;

FIG. 8 is a schematic view of the invention being deflated and recovered;

FIG. 9 is a schematic view of the control system of the invention in use;

FIG. 10 is a schematic view of the control display of the invention;

FIG. 11 is a schematic view of the invention in use in a favorable current;

FIG. 12 is a schematic view of the invention in use in an unfavorable current;

FIG. 13 is a partial cutaway view of an embodiment of the invention;

FIG. 14 is a partial cutaway view of an embodiment of the invention;

FIG. 15 is a cutaway detail view of an embodiment of the invention;

FIG. 16 is a cutaway detail view of an embodiment of the invention;

FIG. 17 is a cutaway detail view of an embodiment of the invention;

FIG. 18 is an elevation view of the spool of an embodiment of the invention; and

FIG. 19 is a cutaway detail view of an embodiment of the invention.

### DETAILED DESCRIPTION OF THE INVENTION

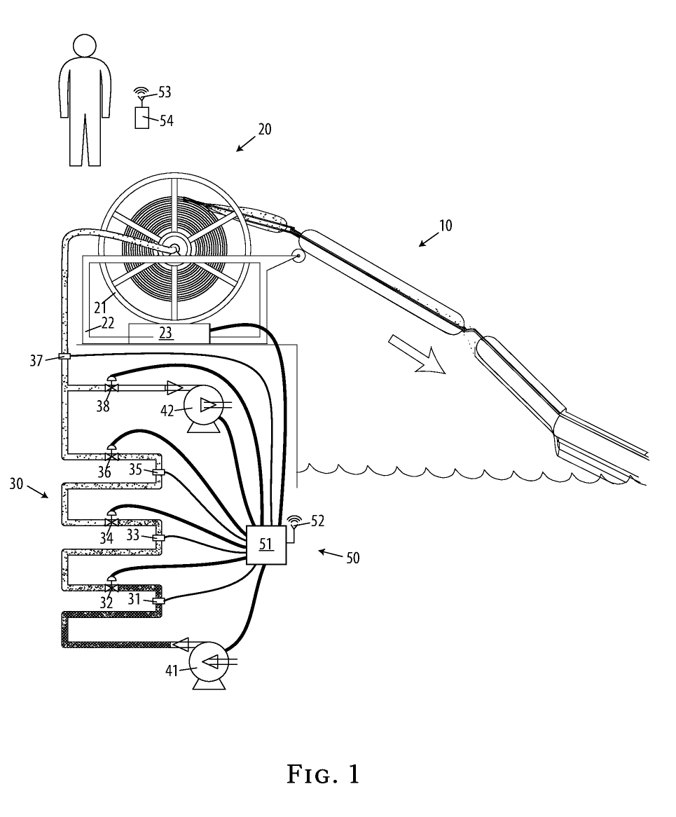

Referring to FIG. 1, our invention provides an on-board spool-able re-useable containment boom 10 capable of being deployed and recovered for training and testing purposes, and of being deployed in the event of an oil spill or similar floating contamination of water, under the control of a pneumatic control system 50 monitored and controlled by an operator through a control display 54.

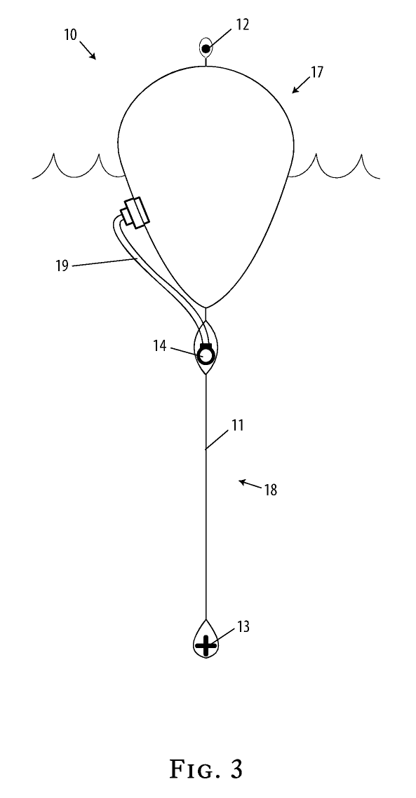

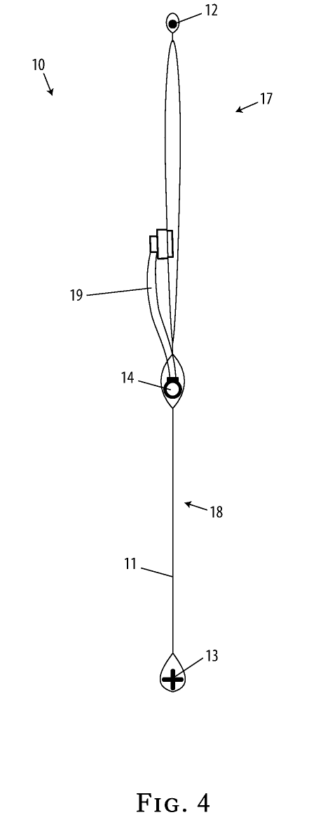

Referring to FIG. 3 and FIG. 4, the on-board spool-able re-useable containment boom 10 has spool-able re-inflatable float sections 17 which are sequentially inflated during deployment and sequentially deflated during recovery, causing the containment boom to float in the proper orientation when inflated, with the spool-able containment skirt 18 suspended below the surface of the water, and causing the containment boom to lie substantially flat and capable of being spooled and stored when deflated. When deployed, the containment boom sits in a substantially vertical orientation with an upper edge and an upper portion lying above the waterline, and a lower edge and a lower portion lying below the waterline.

The upper-to-lower dimension of the spool-able re-useable containment boom 10, and the dimensions of the spool-able re-inflatable float sections 17 and the spool-able containment skirt 18, will depend upon the nature and conditions of the body of water, the work being performed, and the possible oil or contaminate spillage that might be encountered. Deeper offshore water and larger waves will require a longer skirt and proportionately larger float sections than shallower near-shore or inland water will, generally. In a preferred embodiment, the upper-to-lower dimension of the spool-able re-useable containment boom is between 3 feet and 5 feet, inclusive, with the spool-able containment skirt comprising very roughly 60 percent of that distance, and the float sections, when deflated, comprising most of the remainder of that distance.

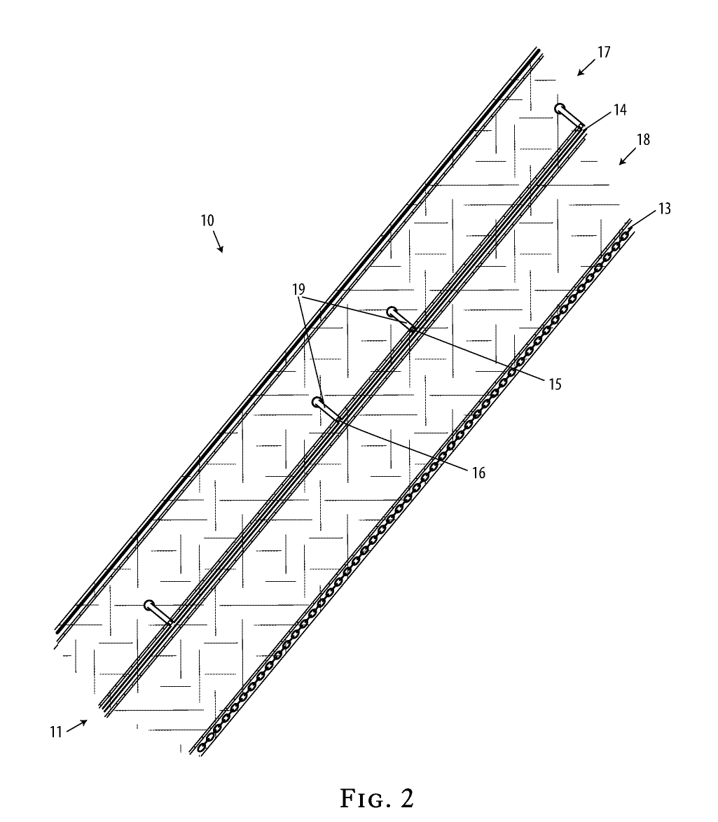

Referring to FIG. 2, the spool-able re-useable containment boom 10 is constructed from a flexible non-permeable sheet material 11 such as a polymeric plastic. The sheet material should be waterproof, petrochemical-proof, dispersant- and solvent-proof, and should hold air pressure. Creation of the spool-able re-inflatable float sections 17 from a double thickness of sheet material can be accomplished by making heat-welded or solvent-welded seams, or by gluing. The sheet material and the seams forming the float sections should be capable of holding air pressure in the range of from 1 to at least 6 p.s.i. without bursting or otherwise failing, and a failure threshold of 10 p.s.i. would be desirable to provide a large margin of error.

A portion of the flexible non-permeable sheet material 11 forms the spool-able containment skirt 18 of the spool-able re-useable containment boom 10.

A spool-able control rope 12, spool-able ballast chain 13, and spool-able air hose 14 are attached either onto or within channels constructed into the flexible non-permeable sheet material 11 forming the spool-able re-useable containment boom 10. In a preferred embodiment, all three are contained in separate channels formed by seaming an additional layer of sheet material, either by folding the sheet material against itself, or by adding a new strip of sheet material.

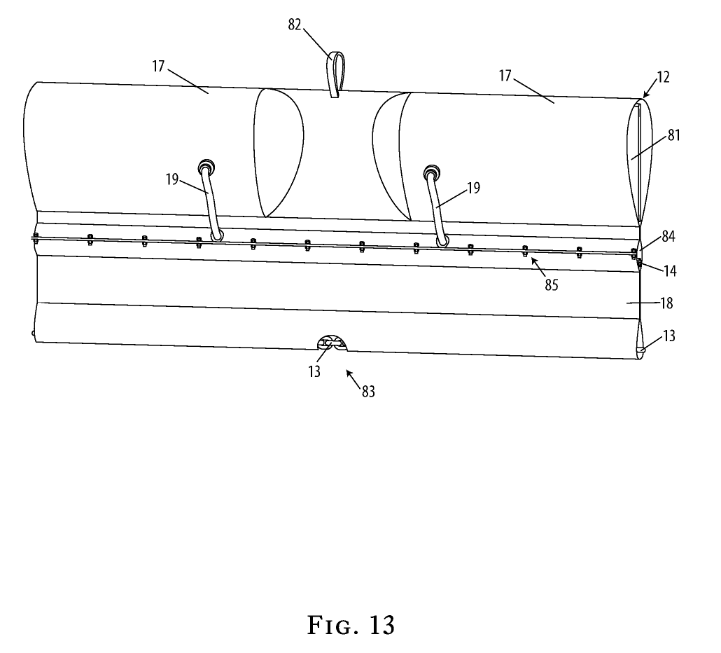

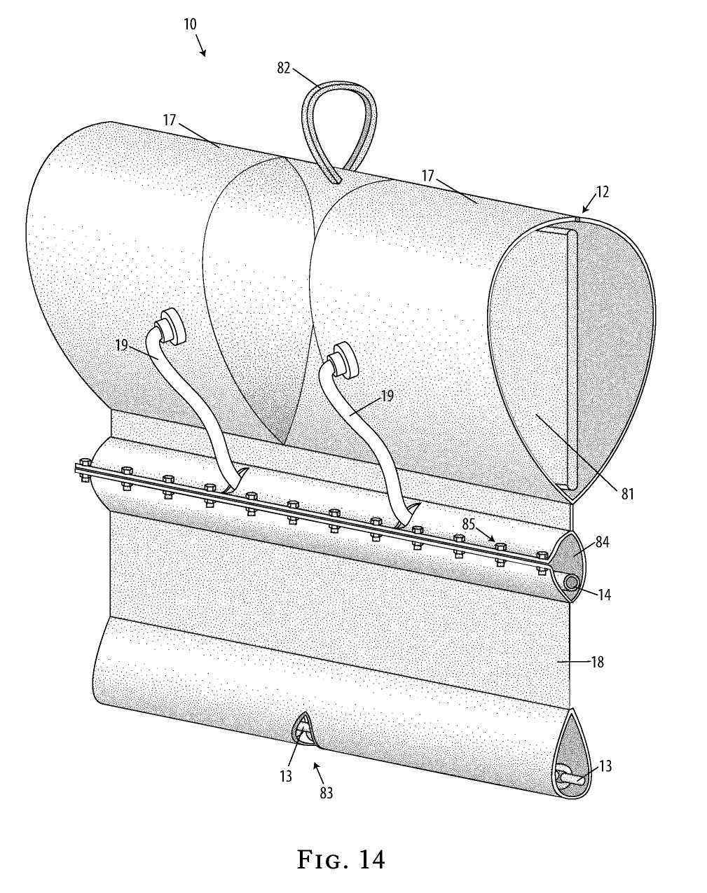

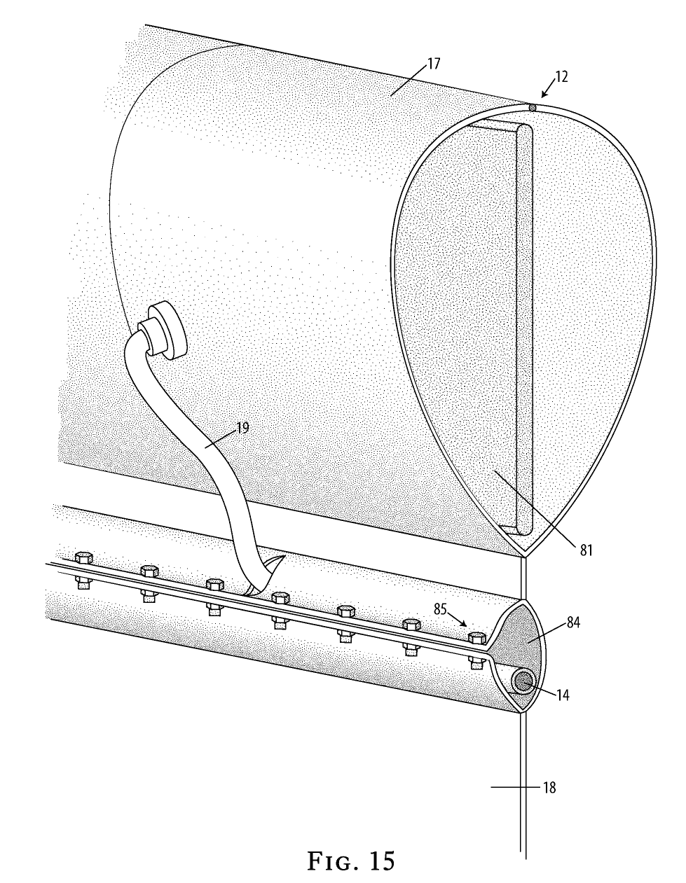

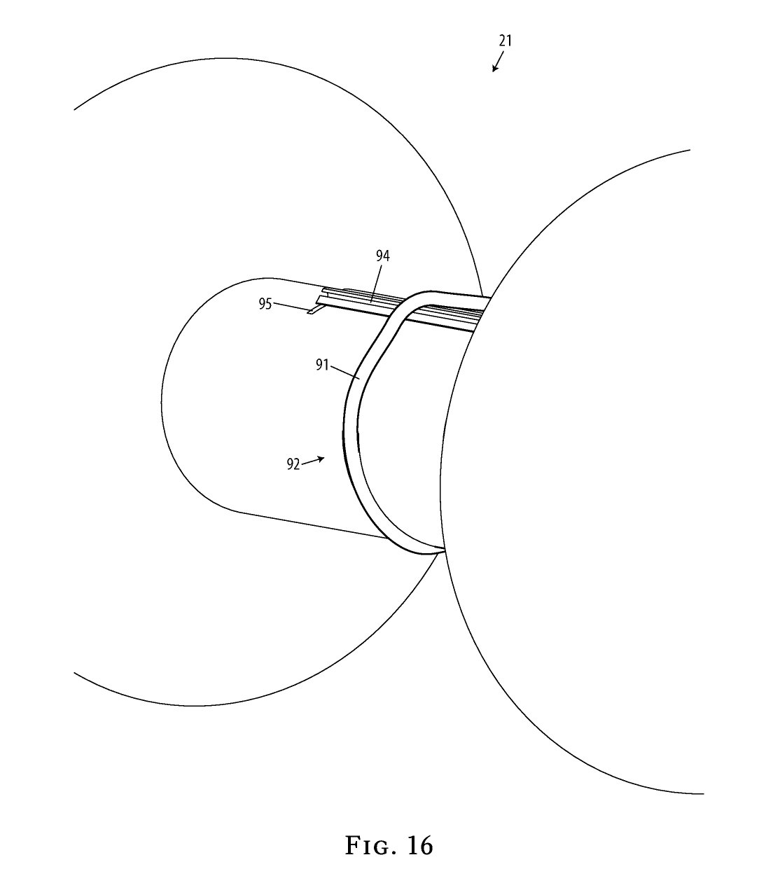

In a preferred embodiment illustrated in FIG. 13, FIG. 14, & FIG. 15, sections of spool-able float panel 81 are also provided inside the spool-able re-inflatable float chambers 17. These spool-able float panels 81 are made of a lightweight buoyant material, such as a closed-cell foam. These spool-able float panels 81 provide buoyancy to the float section even when it is in a deflated state, such as just after deployment, just before recovery, or when damaged. The spool-able float panels 81 also provide a thickness across an area of the boom, when deflated and placed onto the spool, which matches the thickness of the spool-able control rope 12 and the spool-able air-hose 14, thereby presenting a reasonably flat deflated profile which spools easily and evenly.

The spool-able control rope 12 is a primary strength and control member of the containment boom, is attached onto or within a channel at the upper edge, and sits on top of the containment boom when deployed, so that the deployed containment boom can be manipulated and moved as needed. Because the spool-able control rope sits on top of the float sections, the use of a lighter-weight material or even of a buoyant material for the spool-able control rope is beneficial as long as it possesses sufficient tensile strength and sufficient flexibility to be spooled. In a preferred embodiment illustrated in FIG. 13 & FIG. 14, a flexible handle 82 is provided on or between float sections for handling and maneuvering the deployed boom.

The spool-able ballast chain 13 provides a secondary strength and control member and provides adequate ballast weight to pull the spool-able containment skirt 18 downward under water when deployed. A non-buoyant cable or rope, which is heavy or heavy when wet, can be used as a spool-able ballast chain. The weight of the spool-able ballast chain should not be so great as to submerge the inflated float sections when deployed. The buoyancy of the inflated float sections will vary with the size and intended use of a given length of containment boom, and an optimal weight for spool-able ballast chain can be determined in relation to such buoyancy. In a preferred embodiment illustrated in FIG. 13 & FIG. 14, the spool-able ballast chain 13 is enclosed within a sleeve formed at the bottom of the spool-able containment skirt 18, and at a point along each float section, or between sections, anchor points 83 in the form of openings in the sleeve are placed for the purpose of allowing an anchor to be affixed to the spool-able ballast chain 13. The anchor points 83 also allow access to the spool-able ballast chain 13 for the purposes of inspection, maintenance, or cleaning. A ballast chain having a diameter or profile, when spooled, that is larger than the profile of the spool-able control rope 12 and spool-able air hose 14 can still be spooled evenly by folding the ballast chain back across the spool-able containment skirt in a varying pattern which results in more of a helix than a spiral, with the turns of the ballast chain nesting beside each other.

The spool-able air hose 14 attached either onto or within channels constructed into the flexible non-permeable sheet material 11 forming the spool-able re-useable containment boom 10 runs the length of the containment boom, and has connectors at each end which allow separate long lengths of containment boom to be coupled to each other. The spool-able air hose should be capable of delivering positive air pressure of at least 6 p.s.i., optimally 10 p.s.i., over a long run of at least several hundred feet, and of withstanding a vacuum or negative air pressure of at least −10 p.s.i. without collapsing. In a preferred embodiment, the spool-able air hose 14 is placed at the bottom of the float sections 17 and near the middle portion of the containment boom 10, to avoid solar heating or cooling variations and to take advantage of being surrounded by relatively constant water temperatures.

In a preferred embodiment illustrated in FIG. 13, FIG. 14, & FIG. 15, the spool-able air hose 14 is enclosed within an air-hose channel 84 formed as a sleeve around the spool-able air hose 14. The air-hose channel 84 is made to be opened and closed for inspection, maintenance, and cleaning of the air hose, especially after the boom is deployed for a spill and is recovered in a contaminated condition. The air-hose channel 84 is held closed with fasteners 85, which can be connected and disconnected. In a prototype of the invention, the fasteners 85 are nylon nuts and bolts. The fasteners 85 could be of a number of types, and could, for example, be either reusable or one-use, replaceable types. The fasteners 85 should be made of a non-sparking material that can withstand water, seawater, and the oil and contaminates likely to be encountered in use. A non-sparking metal such as brass might be used, or any of a number of plastics and composite materials.

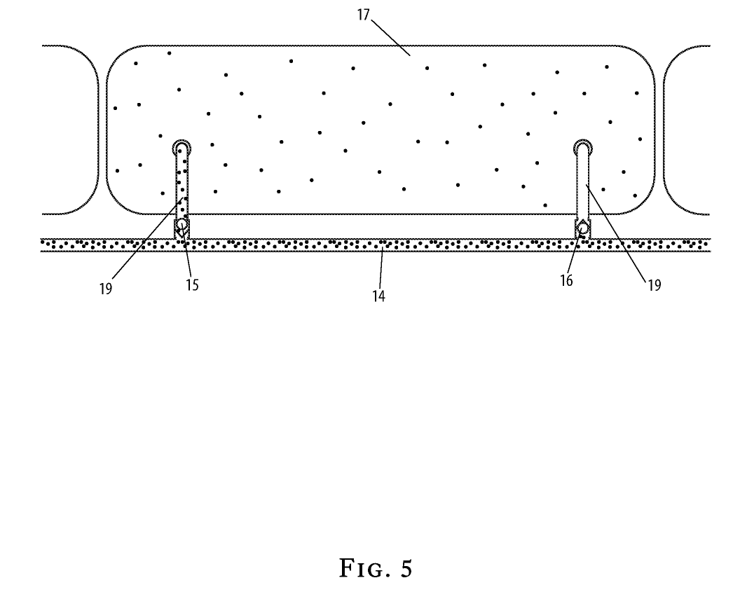

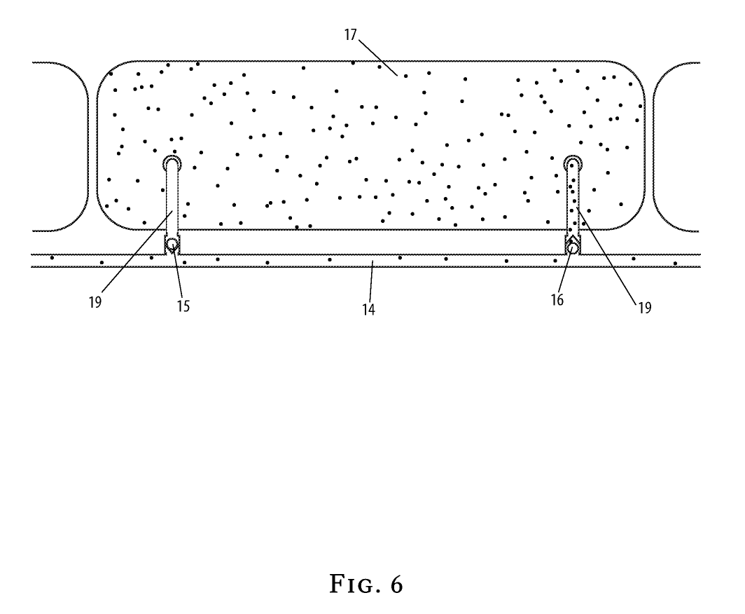

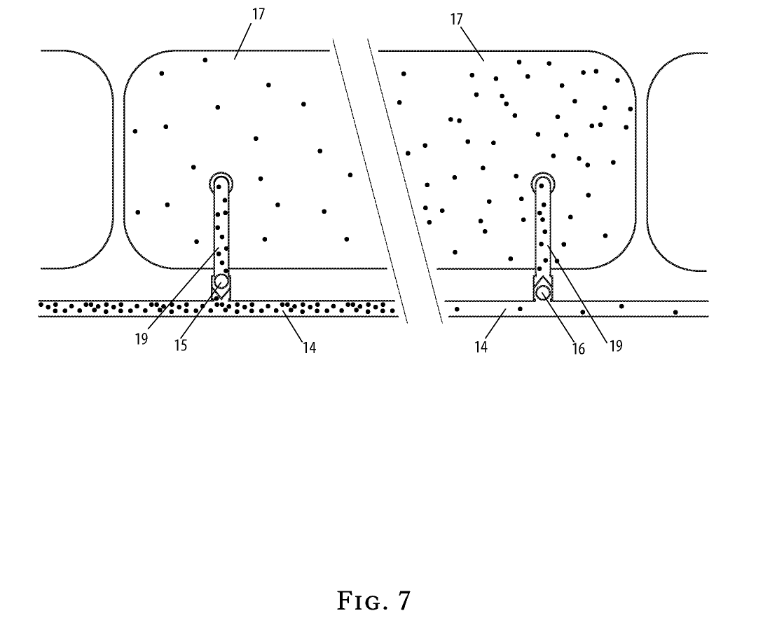

Referring particularly to FIG. 5, FIG. 6, & FIG. 7, each re-inflatable float section 17 is seen in pneumatic connection, through jumper tubes 19, with the spool-able air hose 14 through a filling valve 15 and an emptying valve 16. Both valves are pressure-calibrated one-way or check valves, which can be physically separate, can be housed in a common casing, or can be a combination valve performing the two functions. The filling valve 15 and the emptying valve 16 each respond to pressure differentials of different set thresholds between the pressure in the spool-able air hose 14, which is substantially the same all along the long run of the spool-able air hose, and the internal air pressure in each individual float section.

The filling valve 15 allows the entry of air from the spool-able air hose 14 into the float section 17 up to a closing threshold of the target optimal pressure for the float section, where the float section is sufficiently buoyant but not in danger of bursting or otherwise failing from over pressure. This target optimal pressure will vary with the dimension of containment booms for different uses and conditions. In a preferred embodiment, for a containment boom of deployed vertical length of 3 feet to 5 feet, the target optimal pressure for the floating sections is from 1 to 6 p.s.i., more preferably from 2.5 to 5 p.s.i. The closing threshold of the filling valve would therefore be from 2.5 to 5 p.s.i.

The emptying valve 16 allows evacuation of the air from a float section when a vacuum or negative air pressure over an opening threshold is created in the spool-able air hose 14, but does not allow air to escape from a float section that is properly inflated at the target optimal pressure when there is only a small differential in pressure between the float section and the air hose. The emptying valve also acts as a safety release valve to release pressure from a float section that might be experiencing an overpressure condition resulting from something such as solar heating, as long as the pressure in the air hose is not similarly overpressured, and therefore a pressure differential exceeding the opening threshold exists. The opening threshold pressure differential should be from 2 to 3 times the target optimal pressure for the float section, therefore, in a preferred embodiment, from 5 to 15 p.s.i.

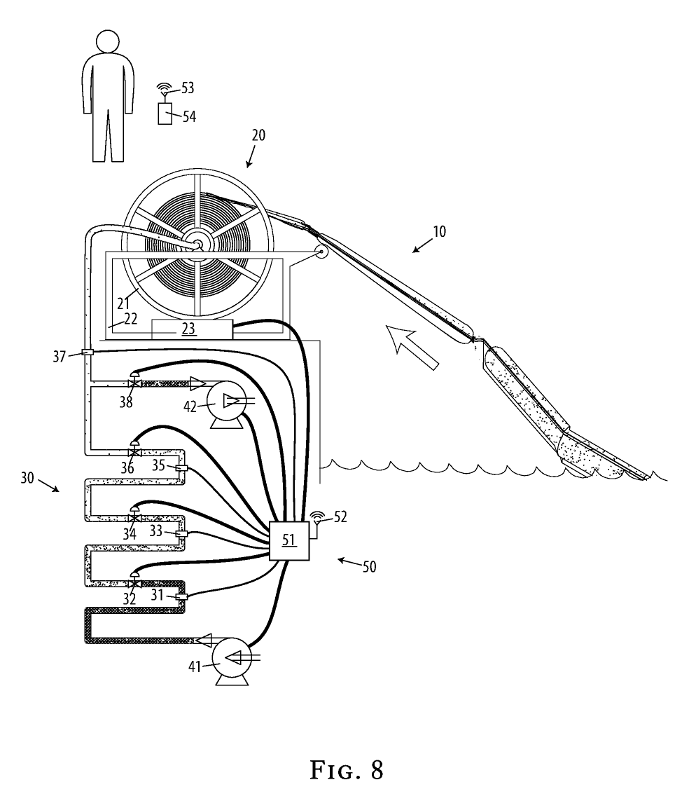

Referring again primarily to FIG. 1 (deployment) and FIG. 8 (recovery) the deflated, un-deployed containment boom is stored upon and deployed and recovered from a mountable reversible boom deployment unit 20, comprising a mountable spool of deflated boom 21 on a spool-mounting frame 22 driven at variable controllable speeds in outbound and inbound directions by a spool motor 23. Each mountable spool of deflated boom 21 contains a long length of containment boom, varying according to size of boom needed for specific conditions and size and weight consideration for the boom deployment unit on the deck of a specific vessel. More than one spool of deflated boom is anticipated to be carried on a vessel, such that multiple spools of boom can be deployed or recovered consecutively. The leading and trailing edges of the containment boom on any given spool of deflated boom are fitted with standard connector fittings known in the art and approved by overseeing entities, allowing multiple spooled sections of boom to be physically connected edge to edge, and pneumatically connected air hose to air hose. In a preferred embodiment, each mountable spool of deflated boom 21 is approximately 6 feet in diameter and deep enough to accommodate the 3 to 5 feet dimension of the deflated boom.

When a spool of deflated boom 21 is mounted on the spool-mounting frame 22, the standard pneumatic connector on the spool-able air hose 14 at the center of the spool, at the trailing edge of that length of containment boom, is connected to the pneumatic control pathway 30 that supplies the spool-able air hose, and the entire length of any connected spool-able air hoses, with variable and controlled positive and negative air pressures. Due to the weight of the boom 10 as it is wound on the spool 21, the inflation of the boom 10 will not take place at the force of 0.5 lbs. per square inch until the boom comes off the spool 21.

Positive air pressures are obtained from a compressed air source 41, which could be a vessel's common compressed air supply or a dedicated air compressor, and a vacuum source 42, which could be a vacuum pump. The initial supply of compressed air should be at relatively high pressure in order to ensure a steady flow of lower pressure into the spool-able air hose of a section of containment boom being deployed.

In a preferred embodiment, having a target optimal pressure of 3 p.s.i., the deflated containment boom 10 while still wrapped on the spool 21 will not tend to inflate when the spool-able air hose 14 contains a positive 3 p.s.i. of air pressure. This is because that low level of pressure cannot overcome the pressure of even a fairly loose wrapping on the spool. As the deflated containment boom comes off the spool during deployment, each consecutive float section 17 will quickly accept 3 p.s.i. of air pressure through that section's filling valve 15. An adequate flow of air is needed at that stage in order to quickly fill that section to capacity before or just as that section goes into the water. After the initial deployment, individual float sections will be subject to fluctuations in pressure due to warming or cooling effects of sun, air, and water. If a float section's pressure goes below the closing threshold of the filling valve 15, which is the target optimal pressure (3 p.s.i. for this embodiment), the filling valve will open and accept air from the spool-able air hose 14, which is maintained at optimal pressure or 3 p.s.i. during the time the containment boom is in the water. If a deployed float section's pressure goes above the optimal pressure in the spool-able air hose to double or triple the optimal pressure (6 to 9 p.s.i. here), the emptying valve 16 will open because the pressure-differential threshold will have been reached, and the excess pressure from that section will go into the lower-pressure spool-able air hose.

During recovery, a negative air pressure or vacuum is applied to the spool-able air hose 14, of a magnitude of at least the emptying valve pressure-differential threshold plus the target optimal pressure, so that a float section at, for example, a half-pound of pressure would still be further emptied because its emptying valve will still be open. As recovered containment boom is wound back onto the spool, the consecutive float section closest to the spool will most readily give up air to the vacuum applied to the spool-able air hose and will collapse to be re-wound flat on the spool. The vacuum will weaken at points further down the still-deployed containment boom, because the air given up by the closest float sections will weaken it, and the still-deployed containment boom will not lose its buoyancy while still in the water, which would make recovery more difficult.

In order to ensure the quick inflation and deflation of float sections before they go into and after they come out of the water, and to allow the containment boom to adjust to changing conditions while deployed, accurate and ongoing control and adjustment of the pressure or vacuum in the spool-able air hose 14 is required, and is supplied by the pneumatic control pathway 30 controlled by the control system 50.

The pneumatic control pathway 30 has at least one pressure sensor 37, at a point closest to, and at equal pressure with, the spool-able air hose 14, at least one pressure regulating valve 32, 34, 36 to reduce higher pressures to lower pressures having a sufficiently high flow rate, and at least one vacuum and release valve 38 to bleed off any high back pressure and to apply negative pressure for deflation. In a preferred embodiment, the pneumatic control pathway 30 steps the air pressure down in 2 stages and then releases low pressure into the spool-able air hose in another separate stage, comprising a high pressure sensor 31, a high-to-medium pressure air valve 32 to step the pressure down, a medium pressure sensor 33, a medium-to-low pressure air valve 34 to step the pressure down further, a low pressure sensor 35, a low pressure air valve 36 to release low pressure into the spool-able air hose, an incorporated-air-hose pressure sensor 37 constantly monitoring the actual pressure at the spool-able air hose, including any back pressure from deployed sections of boom, and a vacuum and release valve 38 for bleeding off any excess pressure and for applying negative pressure either for extreme pressure corrections or for deflating and recovering containment boom.

The control system 50 automatically controls the pneumatic control pathway 30 in coordination with the rate that containment boom is deployed out or recovered in by the speed and direction of the spool motor 23. The desired direction and speed of the spool motor, and therefore the desired rate of deployment or recovery, is ultimately set by an operator through a control display 54. To the extent that the operator-set speed can be realized, and responding to changing conditions such as changes in the air supply or changes in the incorporated-air-hose pressure caused by, for example, transition between air at one temperature and water at another temperature, or failure of an individual float section, the control system 50 finely adjusts the speed of the spool motor in coordination with adjustments of the applied positive or negative air pressures from the pneumatic control pathway 30, resulting in the proper quick inflation or deflation of the appropriate float sections 17 before those sections go into or after those sections come out of the water, avoiding the undesirable sinking effects of deploying boom with under-pressured float sections into the water or recovering boom with under-pressured float sections from the water.

The control system 50 comprises a control manifold 51 in communication with a control display 54 through which an operator can exert control over deployment or recovery and can monitor the deployment or recovery operations. In a preferred embodiment, such bidirectional control communication is implemented as wireless signals through a control manifold antenna 52 and a control display antenna 53.

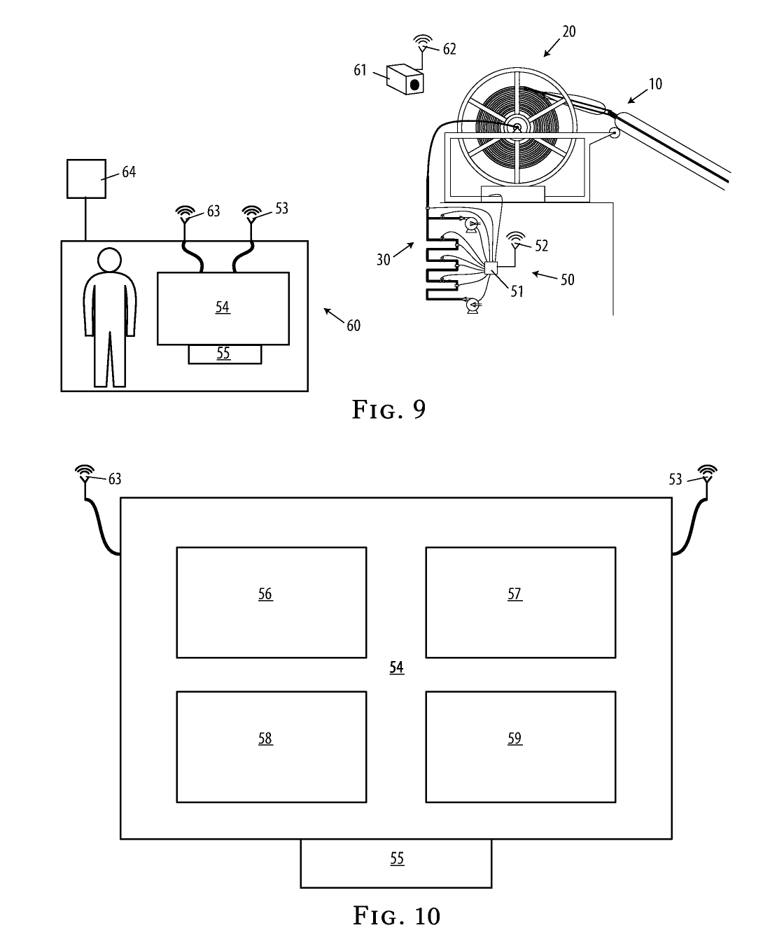

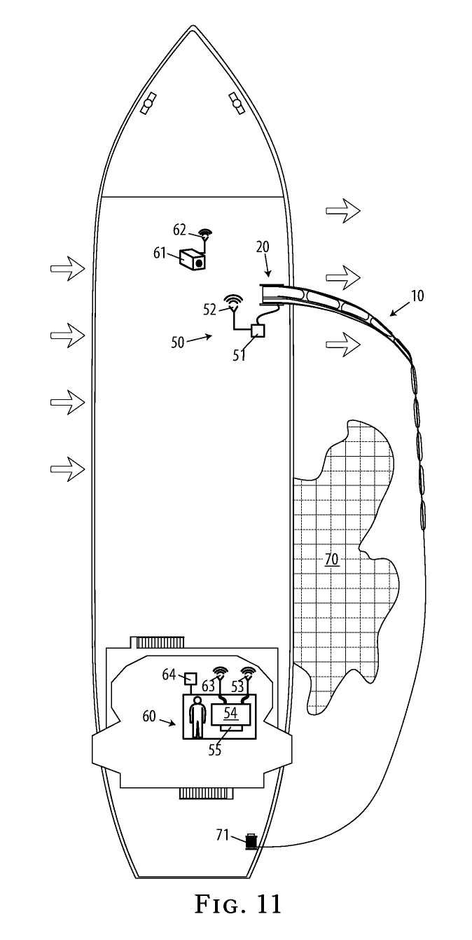

Referring to FIG. 9 & FIG. 10, basic deployment and recovery operations can be managed through a few simple commands from the operator. But deployment of containment boom around an actual oil spill, and training and testing in preparation for an actual oil spill, is a serious undertaking, subject to regulatory oversight and carrying a threat of severe penalties, and therefore justifies a greater amount of automatically assisted operator control, and a large amount of data reported and recorded or logged by the system. Such data can be used to analyze and improve training and testing, and in the event of an oil spill can be used to improve the effectiveness of the response in real time and to have a detailed record of the response for post-oil-spill analysis, investigations, or litigation.

In a preferred embodiment, a control house 60 is provided to house the control display 54 equipment and operator during all weather conditions. If the control house is remote from the mountable reversible boom deployment unit 20, an observation camera 61 having an observation camera transmit antenna 62 can be mounted at the deployment unit, with its video signal sent to be received by the observation camera receive antenna 63 at the control house 60. A weather station 64 reporting conditions may be included as well.

For full control, reporting, and recording of deployment or recovery operations, the control display 54 can have a control manifold keyboard 55, through which an operator can exert automatically assisted control of the operations, a control manifold display 56 reporting all or selected real-time data from the control manifold 51, an observation camera display 57 showing the operations in real time, a weather and conditions display 58, and logged-data display 59 showing real-time data as it is being recorded or showing logged data for reference or review.

In use, in a preferred embodiment where the target optimal pressure for the float sections 17 is 3 p.s.i., the closing threshold for the filling valves 15 is 3 p.s.i., and the opening threshold for the emptying valves 16 is 6 p.s.i., in a deployment operation an operator would initiate through the control display 54 the deployment of an already-mounted spool 21 of deflated containment boom 10. The control manifold 51 causes the spool motor 23 to rotate the spool in the appropriate direction at the desired speed, deploying the containment boom. Simultaneously, the control manifold 51 senses the pressure via pressure sensor 37 at equal pressure with the spool-able air hose 14, and senses the pressures at intermediate pressure sensors 31, 33, 35 in the pneumatic control pathway 30. If activation of the compressed air source 41 is needed, such activation is performed. The control manifold adjusts any intermediate pressure control valve or valves 32, 34 in order to obtain an appropriate intermediate pressure at a pressure sensor 35 on the higher-pressure side of the low-pressure air valve 36, and opens the low-pressure air valve to release the target optimal pressure of 3 p.s.i. through the pressure sensor 37 in the pneumatic control pathway 30 at equal pressure with the connected spool-able air hose 14. The float section 17 at the leading edge of the unspooling containment boom, starting at essentially no pressure, begins quickly pressurizing because the filling valve 15 stays open and accepting air from the spool-able air hose until pressure in that float section reaches the closing threshold of 3 p.s.i. At that point, the leading-edge float section is properly pressurized and is close to entering or is just entering the water, and the inflating process is repeated for each consecutive float section coming off the spool.

For the deployed float sections of the containment boom already in the water, if the air pressure drops below 3 p.s.i., the filling valve will open again and accept air from the spool-able air hose 14, which is maintained at 3 p.s.i. If the air pressure in a float section increases up to the emptying valve 16 threshold opening pressure of 6 p.s.i above the spool-able air hose pressure of 3 p.s.i., which is a float-section pressure of 9 p.s.i., the emptying valve 16 will open and allow pressure to escape into the spool-able air hose. The occurrence of already-deployed float sections taking pressure from or adding pressure to the spool-able air hose 14 affects the pressure in the spool-able air hose as dips or surges in pressure, which are detected by the control manifold 51 through the sensor 37 at a point at equal pressure with the spool-able air hose. Dips of low pressure can be compensated for by the control manifold 51 further opening the low-pressure air valve 36 plus any intermediate valves needed, increasing the air pressure in the air hose. Surges of high pressure can be released by the control manifold 51 opening the vacuum and release valve 38, briefly for bleeding off small surges to atmospheric pressure, or activating the vacuum source 42 to apply negative air pressure to any surge of sufficient magnitude to warrant such remediation.

After deployment is completed, pressure in the several float sections is maintained at between 3 and 9 p.s.i. through the operation of each float section's filling and emptying valves, with the spool-able air hose 14 maintaining a pressure of 3 p.s.i.

In use, in a recovery operation of a preferred embodiment having the same parameters, an operator would initiate recovery through the control display 54. The control manifold 51 causes the spool motor 23 to rotate the spool in the appropriate direction at the desired speed, recovering the containment boom. Simultaneously, the control manifold 51 closes the low-pressure air valve 36 and adjusts any intermediate pressure control valve or valves 32, 34 as needed, and activates the vacuum source 42 if activation is needed. While sensing the pressure in the pneumatic control pathway 30 at a pressure 37 at equal pressure with the spool-able air hose 14, the control manifold opens the vacuum and release valve 38, which has a vacuum behind it, in a constantly adjusted amount sufficient to apply a steady negative air pressure of −7 p.s.i. to the spool-able air hose. That vacuum or negative pressure is sufficient to ensure the opening of each float section's emptying valve 16 at the threshold pressure differential of 6 p.s.i. By maintaining a steady negative air pressure of −7 p.s.i., the vacuum on the spool-able air hose at the float section closest to being re-wound on the spool is sufficient to deflate that float section, but the vacuum is weakened to less than 6 p.s.i. in the portions of the air hose more remote from the vacuum source, and no air is extracted from the more remote float sections still deployed in the water. The control manifold automatically coordinates the speed of the spool motor 23 with the amount of vacuum applied in order to ensure that the closer float sections are deflated without prematurely deflating more remote float sections still in the water.

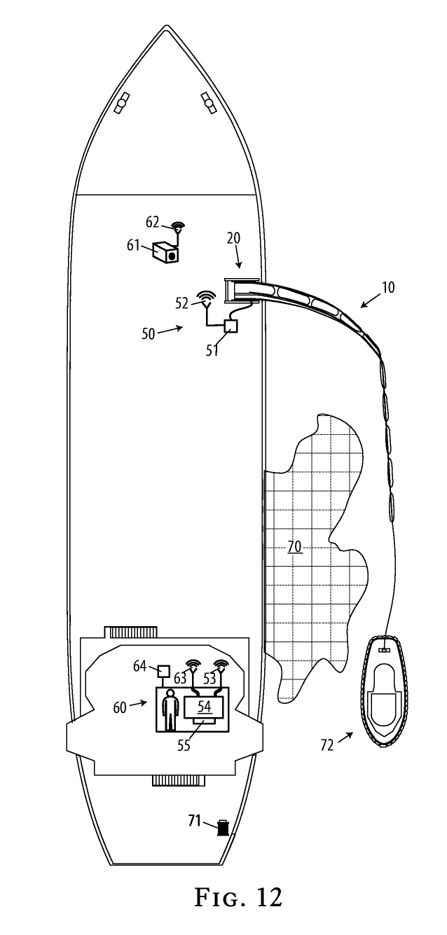

Referring to FIG. 11 & FIG. 12, in the use of a preferred embodiment of the invention in containing spilled oil 70 from on board a waterborne vessel, a determination is first made whether current and wind conditions are such that deployed containment boom 10 will float in a favorable direction to be able to begin deploying the boom while retaining the leading end of a lead line aboard the vessel, floating the deployed containment boom around the spilled oil, and securing the lead line to a winch 71 in order to form a properly deployed boom. If current and wind conditions are not favorable to floating the boom around the spilled oil 70, then an assist vessel 72 can be used to tow the leading edge of the containment boom in the proper path to form a properly deployed boom.

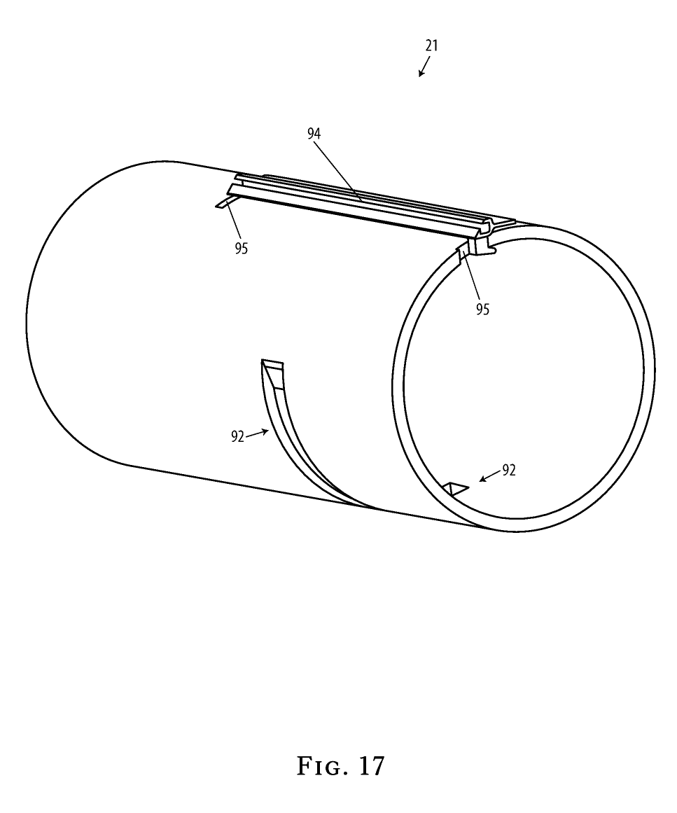

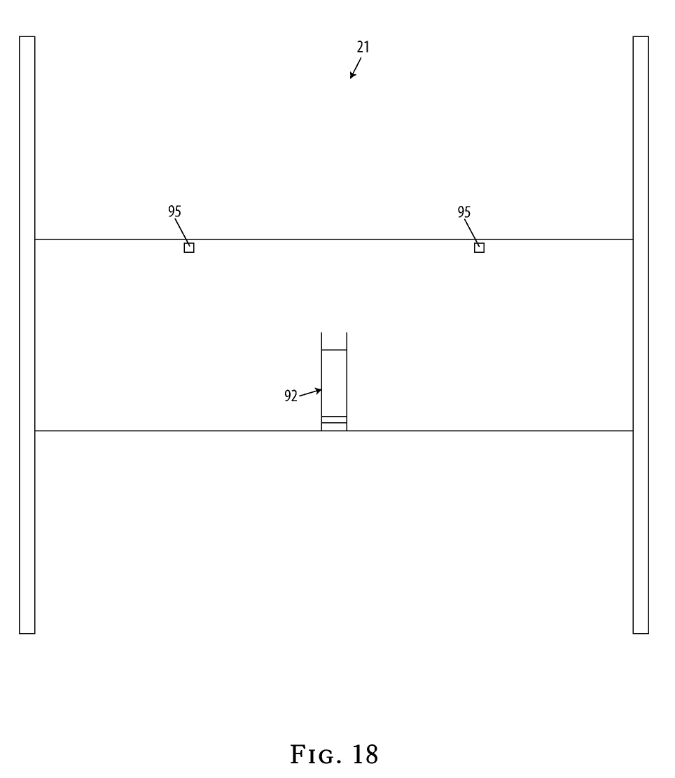

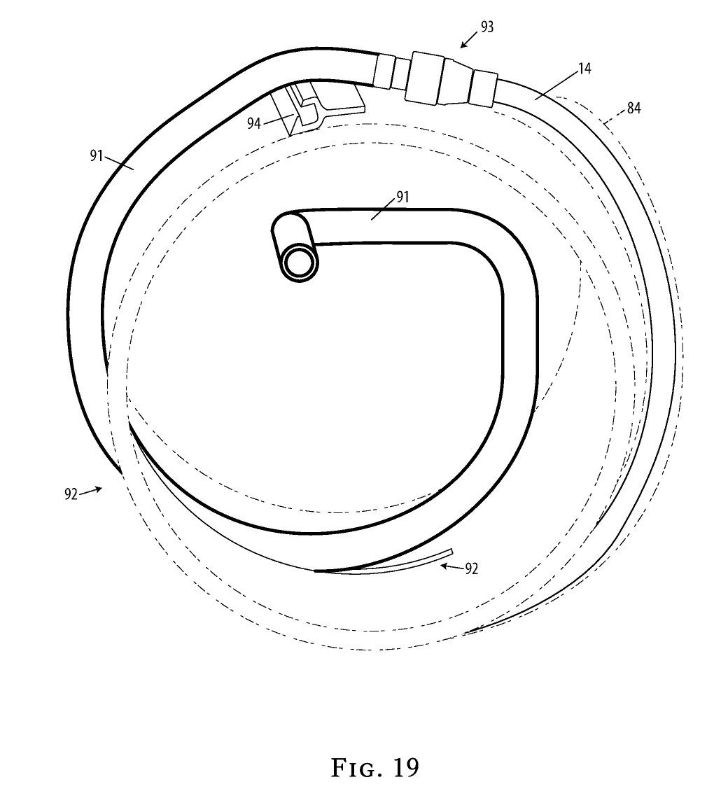

Referring to FIG. 16, FIG. 17, FIG. 18, & FIG. 19, the edge or end of a length of boom can be removably attached to a spool using a boom-unit connector 94 attached to boom-attachment receivers 95. In a preferred embodiment illustrated, the boom-unit connector 94 is a stiff strip having provisions for making end-to-end connections of lengths of boom and having hook-like protrusions which fit into holes or slots in the core of the spool that serve as the boom-attachment receivers. Air pressure and vacuum are supplied to the spool-able air hose 14 through hydraulic tubing 91 passing through a ramped pass-through 92 in the core of the spool. The placement of the boom-attachment receivers 95 and the ramped pass-through 92 are such that the sturdier hydraulic tubing 91 passes over the boom-unit connector 94 before terminating in a quick-release air-hose connector 93 that connects to the spool-able air hose 14, which might be pinched or restricted by being passed over the boom-unit connector 94. The location and configuration of the ramped pass-through 92 in the core is meant to support the hydraulic tubing against bending or crimping pressure from the spooled boom.

Many other changes and modifications can be made in the system and method of the present invention without departing from the spirit thereof. We therefore pray that our rights to the present invention be limited only by the scope of the appended claims.

I claim:

1. An on-board spool-able re-useable containment boom system for deployment from a waterborne vessel, comprising:
(i) a plurality of inflatable float sections;
(ii) a spool-able air hose into which positive and negative air pressures are fed by a pneumatic control pathway having sensors, filling valves, and emptying valves in each of the inflatable float sections for controlling pressures from a compressed air source and a vacuum source, the spool-able air hose extending along an entire length of the boom and connected to all said filling valves and all said emptying valves of said inflatable float sections; and
(iii) a spool-able containment skirt formed by a lower portion of the boom below the air hose and below said inflatable float sections;
wherein the containment boom is deployed and recovered on the mountable spool of deflated boom driven by a spool motor; and
wherein an interior of the air hose is maintained at a pre-determined positive air pressure of between 1 p.s.i. and 3 p.s.i. while the boom and the air hose are wound on the spool before deployment of the boom.

2. The on-board spool-able re-useable containment boom of claim 1, further comprising a spool-able control rope.

3. The on-board spool-able re-useable containment boom of claim 1, further comprising flexible handles.

4. The on-board spool-able re-useable containment boom of claim 1, further comprising spool-able float panels.

5. The on-board spool-able re-useable containment boom of claim 1, further comprising filling valves and emptying valves.

6. The on-board spool-able re-useable containment boom of claim 1, further comprising jumper tubes.

7. The on-board spool-able re-useable containment boom of claim 1, further comprising a spool-able ballast chain.

8. The on-board spool-able re-useable containment boom of claim 1, further comprising anchor points.

9. The on-board spool-able re-useable containment boom of claim 1, further comprising an air-hose channel enclosed said spool-able air hose.

10. The on-board spool-able re-useable containment boom of claim 1, further comprising hydraulic tubing for delivering air pressure and vacuum to said spool-able air hose.

11. The on-board spool-able re-useable containment boom of claim 1, further comprising a ramped pass-through adapted to allow passage of hydraulic tubing through the spool core without crimping or restriction.

12. The on-board spool-able re-useable containment boom of claim 1, further comprising a quick release air-hose connector on the spool end of said spool-able air hose.

13. The on-board spool-able re-useable containment boom of claim 1, further comprising a boom-unit connector detachably mountable to the spool core.

14. The on-board spool-able re-useable containment boom of claim 1, further comprising boom-attachment receivers adapted for removable mounting of a boom-unit connector.
